(19) United States
(12) Patent Application Publication
(10) Pub. No.: US 2009/0164098 A1
(43) Pub. Date: Jun. 25, 2009

(54) CONTROLLER FOR INTERNAL COMBUSTION ENGINE

(75) Inventor: Toshiaki UDA, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/336,690

(22) Filed: Dec. 17, 2008

(30) Foreign Application Priority Data
Dec. 21, 2007 (JP) 2007-329594

(51) Int. Cl. F02D 41/00

(52) U.S. Cl. 701/103; 123/435

(57) ABSTRACT

A computer computes the permissible energizing period of a motor based on the motor initial temperature which is computed based on an output signal from a coolant temperature sensor. As the motor initial temperature is lower, the permissible energizing period is set longer Therefore, even if a responsiveness of an intake flow control valves or the motor deteriorates due to extremely low temperature, a situation in which a motor voltage and the driving duty ratio applied to the motor are maximum continues for a long period. The energizing period of the motor is prolonged. An actual valve position of the valve can be controlled to a target valve position.

### CROSS-REFERENCE TO RELATED APPLICATION

This application is based on Japanese Patent Application No.2007-329594 filed on Dec. 21, 2007, the disclosure of which is incorporated herein by reference.

### FIELD OF THE INVENTION

The present invention relates to a controller for an internal combustion engine. The controller is provided with an overheat protection device of a motor which drives a valve disposed in a fluid passage communicated with a combustion chamber of the engine. The valve opens/closes the fluid passage,

### BACKGROUND OF THE INVENTION

JP-2007-068378A shows an intake controller provided with an intake flow control valve which generates an intake vortex in a combustion chamber of an internal combustion engine. The intake flow control valve is provided downstream of a throttle valve. As shown in FIG. 12, the intake controller is provided with an intake pipe 102 defining an intake passage 101 therein, an intake flow control valve 103 controlling a flow passage are of the intake passage 101, and an actuator driving a shaft 104 of the intake flow control valve 103.

The actuator is comprised of a motor 105, a worm gear 111, a helical gear 112, a flexible member 113, an output spur gear 114, an input spur gear 115 and the like. A valve position sensor of a non-contact type (magnetic sensor) is mounted in the actuator for detecting a valve position of the intake flow control valve 103. The valve position sensor is includes a magnet 116 retained and fixed in the input spur gear 115, a pair of yokes arranged as opposed to the magnet 116 and magnetized by a magnetic force of the magnet 116, a Hall IC 117 arranged in a magnetic detection gap formed between the opposing yokes, and the like. A fully open stopper 119 is provided to be capable of contacting the input spur gear 115.

The motor 105 includes a coil which receives an electric power supply so that an actual valve position of the intake flow control valve 103 agrees with a target valve position which is established based on an engine driving condition. During engine starting or at engine idling state, the intake flow control valve 103 is fully closed to generate a turning flow (tumble flow or swirl flow) in the combustion chamber. At normal engine operating, the intake flow control valve is fully opened so that the intake air flows straight in the intake passage 101 without generating the intake vortex.

As described above, the electric power supply to the coil of the motor 105 is variably controlled so that the valve position of the intake flow control valve 103 agrees with the target valve position. In a case that an ambient temperature is very low (for example, −35° C.), a deposit adhering on a vicinity of the intake flow control valve 103 is hardened, the intake flow control valve 103 is frozen, or viscosity of lubricant increases. The driving load of the motor 105 increases, and control responsiveness of the intake flow control valve 103 and the motor 105 deteriorates.

An overheat protection device for a motor is well known. In order to avoid a thermal damage to the coil due to the overheat of the motor, the overheat protection device stops the electric power supply to the coil of the motor if a driving duty of 100% has been applied to the motor for a specified time period or if an energizing period of the motor has been continued for a predetermined time period. The overheat protection device can be mounted on the intake vortex generating device shown in JP-2007-068378A. As described above, if the intake flow control valve is frozen, the intake flow control valve can not be driven even if the electric power is supplied to the motor.

If the driving duty of 100% has been applied to the motor for the specified time period, the coil of the motor may be overheated, When the coil is overheated and the overheat protection device is activated, the electric power supply to the motor is stopped even if the valve position of the intake flow control valve has not reached the target position yet.

### SUMMARY OF THE INVENTION

The present invention is made in view of the foregoing problem and an object of the present invention is to provide a controller for an internal combustion engine which can accurately adjust a valve position to a target valve position even if a responsiveness of a motor or a valve is deteriorated at extremely low ambient temperature.

According to the present invention, a controller restricts an electric power supply to the motor less than a predetermined value when the electric power to the motor has been maximum for a specified period. Alternatively, the controller restricts the electric power supply to the motor less than the predetermined value when a continuous energizing period of the motor exceeds the specified period. The controller can restrict the electric power to stop the motor. The controller includes a temperature sensor which detects a temperature correlative to a motor temperature. The controller makes the specified period longer as the temperature detected by the temperature sensor is lower. Therefore, even if a responsiveness of a valve or the motor deteriorates due to extremely low temperature, a situation in which a motor voltage and the driving duty ratio applied to the motor are maximum continues for a long period. The energizing period of the motor is prolonged. An actual valve position of the valve can be controlled to a target valve position.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing an intake controller for an internal combustion engine in a first embodiment of the present invention;

FIG. 2A is a cross section showing a fully closed position of an intake flow control valve in the first embodiment;

FIG. 2B is a cross section showing a fully open position of the intake flow control valve in the first embodiment;

FIG. 3 is a perspective view showing a valve unit (cartridge) in the first embodiment;

FIG. 4 is a cross section showing an intake vortex generating device in the first embodiment;

FIG. 5 is a block diagram showing an engine control system in the first embodiment;

FIG. 6 is a block diagram showing an H-bridge circuit and a microcomputer (ECU) in the first embodiment;

FIG. 7 is a flow chart showing a drive control of the H-bridge circuit by the ECU in the first embodiment;

FIG. 8 is a flow chart showing the drive control of the H-bridge circuit by ECU in the first embodiment;

FIG. 9 is a flow chart showing the drive control of the H-bridge circuit by ECU in the first embodiment;

FIG. 10A is a characteristic chart showing a permissible energizing period of a motor relative to a coolant temperature;

FIG. 10B is a timing chart showing a battery voltage, a valve position of TCV, an energizing pattern of a motor according to a first embodiment;

FIG. 11 is a characteristic chart showing the permissible energizing period of the motor relative to an engine room temperature (or an ambient temperature) and the battery voltage according to the second embodiment; and

FIG. 12 is a schematic view showing a conventional intake vortex generating device.

### DETAILED DESCRIPTION OF EMBODIMENTS

### First Embodiment

### [Structure of First Embodiment]

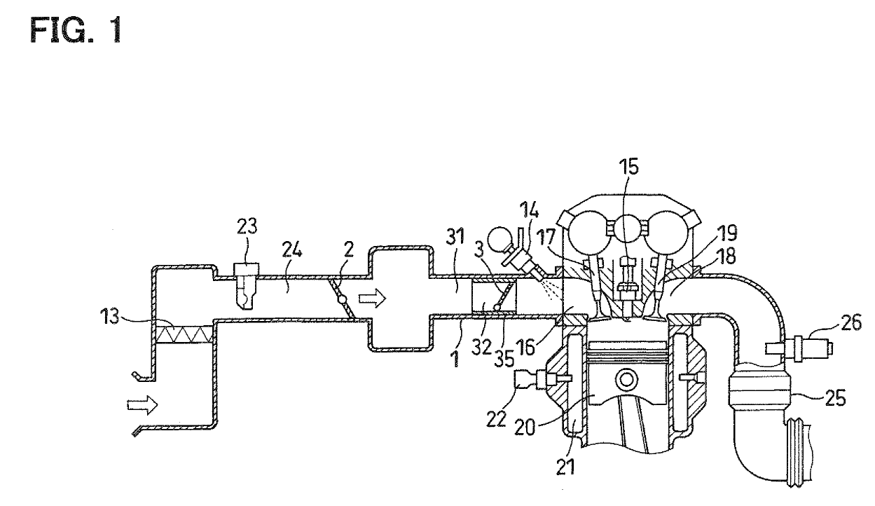

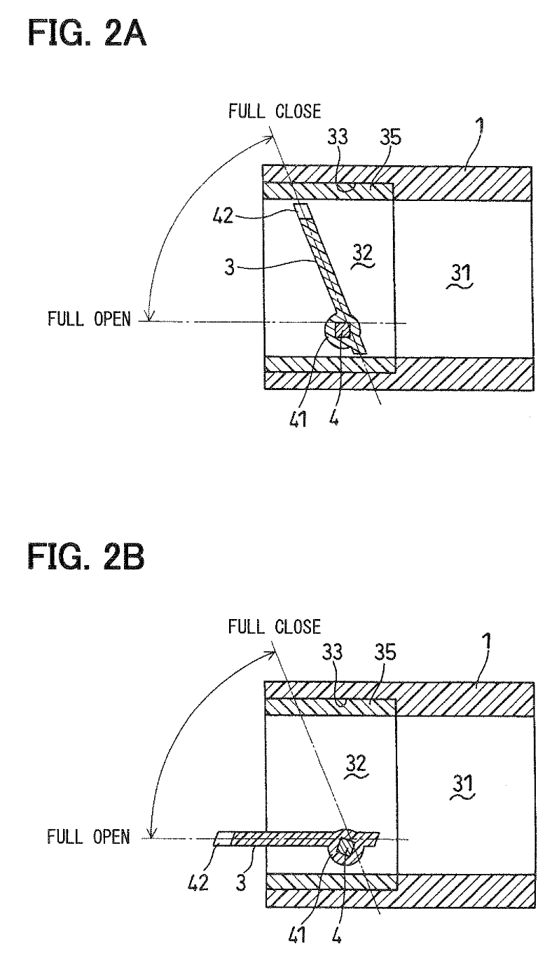

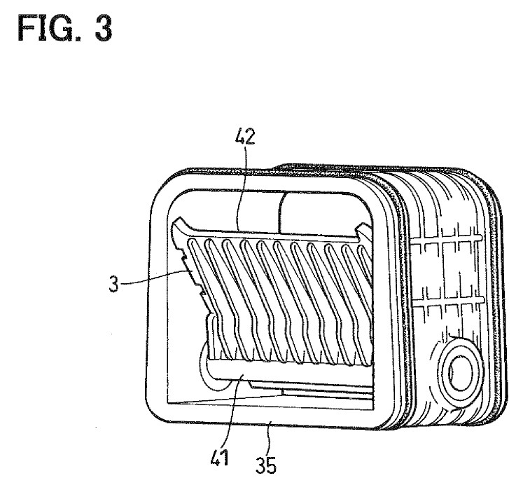

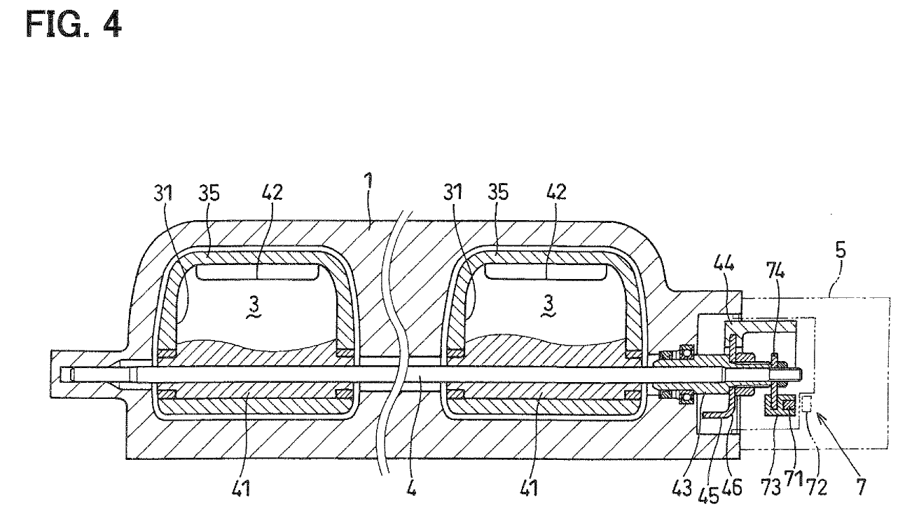

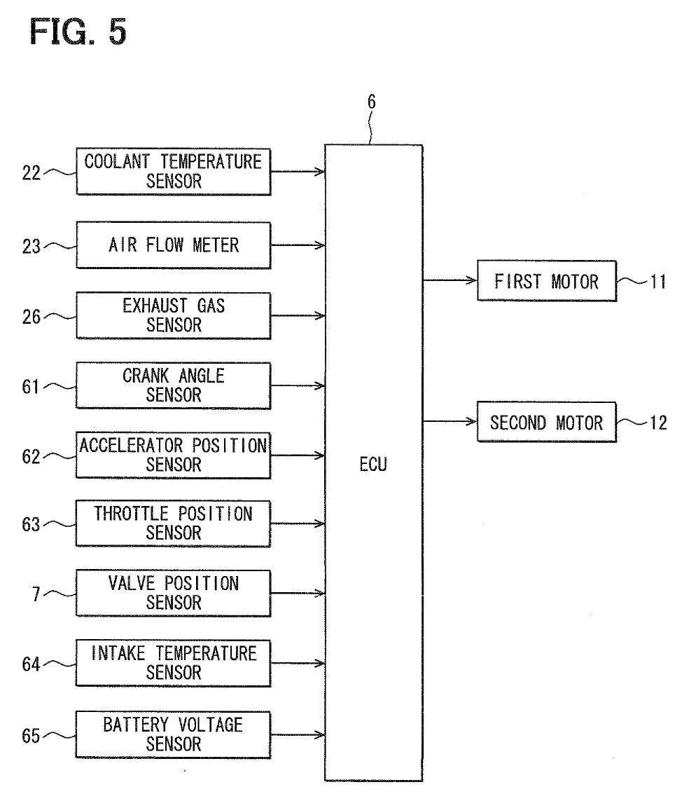

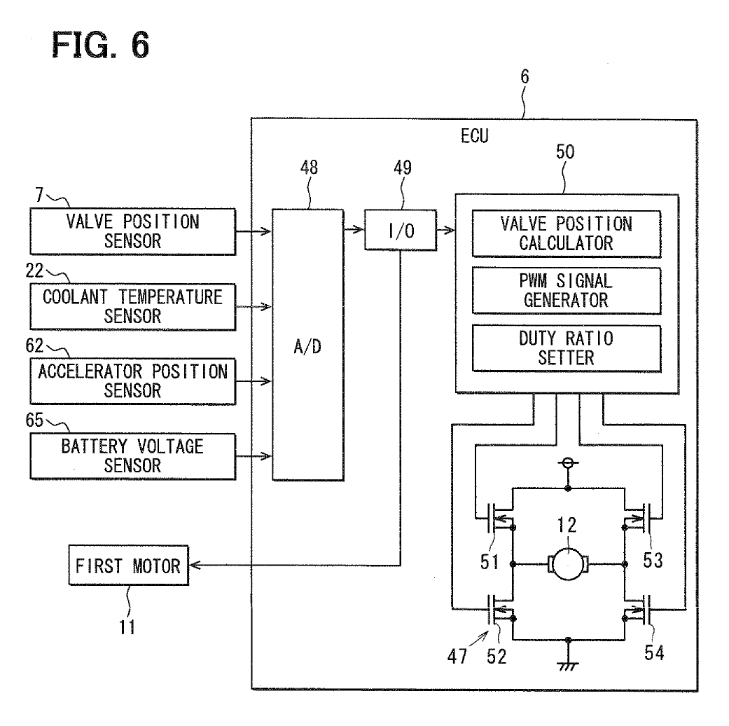

A first embodiment of the present invention will be explained with reference to FIGS. 1 to 10. FIG. 1 is a diagram showing an intake controller for an internal combustion engine. FIG. 2A is a cross sectional view showing a fully closed position of an intake flow control valve. FIG. 2B is a cross sectional view showing a fully open position of the intake flow control valve. FIG. 3 is a perspective view showing a valve unit (cartridge). FIG, 4 is a cross section view showing an intake vortex generating device. FIG. 5 is a block diagram showing an engine control system. FIG. 6 is a block diagram showing an H-bridge circuit and a microcomputer.

A controller for an internal combustion engine in the present embodiment is used as an intake controller (intake passage opening/closing device) for opening/closing an intake passage through which the intake air flows into a combustion chamber of each cylinder. The internal combustion engine has a plurality of cylinders, for example, four cylinders. The intake controller is provided with an electronic throttle controller controlling an intake air flow rate and an intake vortex generating device generating an intake vortex for promoting combustion of an air-fuel mixture in the combustion chamber of each cylinder.

The engine produces a thermal energy by burning in the combustion chamber a mixture of clean intake air filtered in a filter element 13 and fuel injected from an electromagnetic fuel injector 14. The engine is a four-cycle engine in which four strokes of an intake stroke, a compression stroke, a power stroke and an exhaust stroke are repeated periodically. The engine has a cylinder head connected air-tightly to a lower end of an intake manifold 1, a cylinder block forming the combustion chamber between the cylinder head and the cylinder block, and the like. An injector 14 is attached at the downstream portion of the intake manifold 1 (or cylinder head) for injecting fuel into an intake port of each cylinder at an optimal timing. The cylinder head is provided with a spark plug 15 attached thereto so that a tip portion thereof is exposed to the combustion chamber of each cylinder.

Each of a plurality of intake ports 16 formed in one side of the cylinder head is opened/closed by a poppet type of intake valve 17. Each of a plurality of exhaust ports 18 formed in the other side of the cylinder head is opened/closed by a poppet type of exhaust valve 19. A piston 20 connected through a connecting rod to a crank shaft is slidably supported in a cylinder bore formed inside the cylinder block. A coolant temperature sensor 22 is mounted in the cylinder block for detecting a temperature of engine coolant cyclically supplied to a water jacket 21 of the engine.

The intake pipe of the engine is a casing (intake duct and intake introduction duct) in which the intake passage is formed for supplying intake air to the combustion chamber of each cylinder. The intake pipe of the present embodiment is provided with an air flow meter 23 for detecting an intake air flow rate aspired into the combustion chamber of each cylinder. Further, one common intake passage (intake passage of the engine) 24 communicated with the combustion chamber of each cylinder is formed upstream of the intake manifold 1. The exhaust pipe of the engine is a casing (exhaust duct and exhaust discharge duct) in which the exhaust passage is formed for discharging an exhaust gas flowing out from the combustion chamber of each cylinder via an exhaust gas purifying device 25 to an outside. In the present embodiment, for example, a catalyst such as a three-way catalyst for purifying CO, HC, NOx and the like in the exhaust gas is adopted as the exhaust gas purifying device 25. The exhaust pipe of the present embodiment is provided with an exhaust gas sensor 26.

The electronic throttle controller of the present embodiment is a system for varying the intake air flow rate aspired into the combustion chamber of each cylinder in accordance with a throttle opening corresponding to a valve position of a throttle valve 2. The electronic throttle controller is comprised of a throttle body arranged in the intake pipe of the engine, a butterfly type of throttle valve 2 varying an intake air flow rate flowing through the intake pipe (common intake passage 24), a return spring (or default spring) urging the throttle valve 2 in the valve-closing direction (or in the valve-opening direction) and the like.

The throttle body is provided with an actuator for driving a shaft (rotational shaft) supporting and fixing the throttle valve 2 in the valve-opening direction (or in the valve-closing direction). The actuator includes a first motor 11 which generates a drive force upon receiving supply of power, a power transmission mechanism (for example, gear reduction mechanism) for transmitting the drive force of the first motor 11 to the shaft of the throttle valve 2, and the like. The first motor 11 for driving the throttle valve 2 is electrically connected to a battery mounted in a vehicle through a motor drive circuit which is electronically controlled by an electronic control unit (ECU) 6.

The intake vortex generating device of the present embodiment is installed in an engine room of the vehicle, The intake vortex generating device is a system which throttles each passage cross sectional area of a first and a second intake passages 31, 32 communicated with the combustion chamber to generate a longitudinal turning flow (intake vortex:tumble flow) in the combustion chamber. The intake vortex generating device is incorporated in an intake system of the engine together with the electronic throttle controller. The intake vortex generating device is an intake passage opening/closing device of a multiple one-piece type (valve opening/closing device) in which a plurality of valve units are arranged in parallel with each other at constant intervals in an axial direction (rotational shaft direction) of a pin rod (rotational shaft or shaft) 4 inside the intake manifold 1 (housing storage chamber).

The intake vortex generating device is comprised of: the intake manifold 1 connected to the intake pipe of the engine downstream of the throttle body and the surge tank in the intake flow direction; a plurality of intake flow control valves (tumble control valve “TCV”) which are intake control valves controlling intake air flowing in an inside (the first and second intake passages 31, 32) of the intake manifold 1; a pin rod 4 press-fitted into an inside of the intake flow control valve 3 which is a valve body of TCV; an actuator which can integrally change valve positions (rotational angle) of the plurality of the TCVs through the pin rod 4; and ECU 6 for controlling the valve position of TCV in association with each system such as the electric throttle controller, an ignition device and a fuel injection device.

The intake manifold 1 of the present embodiment is the casing (intake introduction duct) which forms the plurality of the first intake passages (fluid passage, branch intake passage) 31 communicated with the combustion chamber of each cylinder in the engine. The first intake passages 31 in a square section and the housing storage chambers 33 in a square section respectively are formed inside the intake manifold 1 by the number corresponding to that of the cylinders. Each first intake passage 31 is connected to each intake port 16 of the cylinder head separately from each other. The housing 35 of the TCV is fitted and retained inside of each housing storage chamber 33.

Each of the plurality of the TCVs is comprised of the housing 35 stored in the housing storage chamber 33 of the intake manifold 1, the intake flow control valve 3 installed inside the housing 35 (second intake passage 32) in such a manner as to be capable of opening and closing the second intake passage 32. In the present embodiment, the housing 35 and the intake flow control valve 3 constitute the valve unit (cartridge) fitted and retained in the housing storage chamber 33 of the intake manifold 1. The intake manifold 1, the plurality of the housings 35 and the plurality of the intake flow control valves 3 are formed integrally by a resin material.

The plurality of the valve units include the plurality of the second intake passages 32 (fluid passage), each being connected corresponding to each first intake passage 31 of the intake manifold 1 and corresponding to each intake port 16 of the cylinder head for each of the plurality of the housings 35. That is, the second intake passage 32 in a square section is formed inside each housing 35. Each of the second intake passages 32 is arranged downstream of the first intake passage 31 in the intake flow direction, and is connected through each intake port 16 of the cylinder head to the combustion chamber of each cylinder separately from each other. Each intake flow control valve 3 is accommodated in each housing 35 in such a manner as to open and close the second intake passage 32.

Each of the plurality of the intake flow control valves 3 is a rotary valve which has a rotational center axis in a direction orthogonal to the axis direction (intake flow direction) of each housing 35 and is connected to one pin rod 4 in a skewer state. In the intake flow control valve 3, a rotational angle thereof (valve position) changes within a valve operable range from a fully open position where an opening area in each second intake passage 32 is maximized to a fully closed position where the opening area in each second intake passage 32 is minimized. In this way, the intake flow control valve 3 rotates relatively to each housing 35 to open/close each second intake passage 32. That is, the passage cross sectional area of each second intake passage 32 is thus throttled.

When the engine is at starting or idling, the plurality of the intake flow control valves 3 are, as shown in FIG. 2A, made to be fully closed by the actuator, particularly the driving force of the second motor 12. That is, each valve position of the plurality of the TCVs is controlled to be in a fully closed position of the valve. The fully closed position of the intake flow control valve 3 means a fully closed state where the intake flow control valve 3 fully closes the second intake passage 32. The fully closed position is a limit position in the other side of a possible operation range of the intake flow control valve 3, that is, a fully closed-side regulation position where a fully closed stopper portion of a stopper lever 45 fitted and fixed on the outer periphery of the joint shaft 4 bumps against a fully closed stopper (not shown) to prevent the intake flow control valve 3 from being furthermore rotated to the fully closed side.

The plurality of the intake flow control valves 3 are, as shown in FIG. 2B, made to be fully opened by the drive force of the second motor 12 when the engine is at an ordinary driving. That is, each valve position of the plurality of the TCVs is controlled to be in a fully open state (fully open position). The fully open position of the intake flow control valve 3 means a fully open state where the intake flow control valve 3 fully opens the second intake passage 32. The fully open position is a limit position in one side of the possible operation range of the intake flow control valve 3, that is, a fully open-side regulation position where a fully open stopper portion of the stopper lever 45 bumps against a fully open stopper to prevent the intake flow control valve 3 from being furthermore rotated to the fully open side. When power supply to the second motor 12 is stopped at engine stopping, each of the plurality of the intake flow control valves 3 is returned back to the fully open position (or state of an intermediate opening which is closed more slightly than the fully open position (intermediate position)) by an urging force of a spring.

Each of the plurality of the valve units has a polygonal hole (square hole) penetrating in the rotational shaft direction of the pin rod 4 for each of the plurality of the intake flow control valves 3. The plurality of the intake flow control valves 3 have a cylindrical rotational shaft (valve shaft) 41 arranged to surround the circumference of the pin rod 4, each being formed of a sheet-shaped valve body extending toward one side (half side) in the diameter direction perpendicular to the rotational shaft direction from the valve shaft 41. In each of the plurality of the intake flow control valves 3, the valve shaft 41 constituting the rotational center is arranged in a position shifted to the half side (lower side in the figure) from the valve center portion of the intake flow control valve 3 in the valve surface direction perpendicular to the plate thickness direction of the intake flow control valve 3. Therefore, the intake flow control valve 3 is of a cantilever type valve. In the present embodiment, by cutting away a part (central portion) of an upper end surface of the intake flow control valve 3, that is, by cutting away the valve upper end surface at the opposite side to the valve shaft, a rectangular opening (notch portion or slit) 42 is formed for generating the tumble flow in the combustion chamber of each cylinder in the engine. The opening 42 may not be provided. In the present embodiment, by cutting away a part of each of the right and left side surfaces of the intake flow control valve 3, a sub-opening having an opening area smaller than that of the opening (primary opening) 42 may be formed.

The pin rod 4 is inserted inside of each polygonal hole formed for each of the intake flow control valves 3 by press-fitting. The pin rod 4 allows the respective valve shafts 41 of the intake flow control valves 3 to be connected in a skewer shape. As a result, the pin rod 4 is one drive shaft which can connect all the intake flow control valves 3 so as to move together. The pin rod 4 is a rotational shaft for changing the valve position of the plurality of the TCVs, and is press-fitted and fixed on an inner periphery of each polygonal hole provided in each of the plurality of the intake flow control valves 3. The pin rod 4 is a shaft in a polygonal section (angular steel shaft), having a cross section vertical to the rotational shaft direction which is formed in a polygonal shape (for example, square shape) and is formed integrally by a metallic material.

The cylindrical joint shaft 43 is fitted and retained on an outer periphery of the pin rod 4 at the other end side (actuator side) in the rotational shaft direction thereof in the present embodiment. The joint shaft 43 is a shaft in a cylindrical section, having a cross section vertical to the rotational shaft direction which is formed in a cylindrical shape and is formed integrally by a metallic material. The joint shaft 43 in the present embodiment is fitted and retained on the outer periphery of the pin rod 4 to connect a final reduction gear 44 of the actuator and the stopper lever 45 retaining and fixing the final reduction gear 44 to the pin rod 4.

The actuator in the present embodiment is comprised of an electric actuator including a second motor 12 generating a drive force, a power transmission mechanism transmitting the rotational motion of the motor shaft (motor shaft or output shaft) of the second motor 12 to the pin rod 4, and an actuator body 5 housing the second motor 12 and the power transmission mechanism therein. The power transmission mechanism is comprised of a gear reduction mechanism which reduces a rotational speed of the second motor 12 to acquire a predetermined reduction ratio and increases the drive force (motor torque) of the second motor 12. The gear reduction mechanism includes a worm gear fixed to the motor shaft of the second motor 12, a helical gear meshing with the worm gear, an intermediate reduction gear meshing with the helical gear, and the final reduction gear 44 meshing with the intermediate reduction gear. The respective gears are rotatably accommodated in the actuator body 5, particularly the actuator case. Since the worm gear and the helical gear are used, the pin rod 4 does not rotate even if a driving force is applied to the pin rod 4 when the electric power supply to the second motor 12 is stopped. That is, unless the second motor 12 is energized to rotate the motor shaft, a self lock effect of the worm gear restricts the rotation of the intake flow control valve 3. A spring may be assembled in the pin rod 4 or the final reduction gear 44 for urging all the intake flow control valves 3 in the valve-opening direction or the valve-closing direction.

The final reduction gear 44 is integrally formed in an arc shape by a resin material The stopper lever 45 is insert-molded inside the final reduction gear 44, being selectively engaged to a fully open stopper (fully open stopper screw) or a fully closed stopper (fully closed stopper screw) supported and fixed in the intake manifold 1. The stopper lever 45 includes a bent portion 46 which is bent in an L-shape. The fully open stopper portion engaged to the fully open stopper is provided at one side in the rotational direction (valve-opening direction) of the bent portion 46 of the stopper lever 45. As a result, when the fully open stopper portion of the stopper lever 45 bumps against the fully open stopper, the valve position of the TCV is regulated to be in a fully open state of valve opening (fully open position), The fully closed stopper portion engaged to the fully closed stopper is provided at the other side in the rotational direction (valve-closing direction) of the bent portion 46 of the stopper lever 45. As a result, when the fully closed stopper portion of the stopper lever 45 bumps against the fully closed stopper, the valve position of the TCV is regulated to a fully closed state (fully closed position).

The second motor 12 is electrically connected to the battery mounted in a vehicle through the H-bridge circuit 47 which is electronically controlled by the ECU 6. The second motor 12 is a DC motor with a brush, which is comprised of a rotor (armature) integral with the motor shaft, a stator (field) arranged to be opposed to the outer periphery side of the rotor, and the like. The rotor of the second motor 12 has a core around which a coil is wound. The stator of the second motor 12 has a motor yoke (magnetic element) or a motor frame retaining a plurality of permanent magnets on its inner periphery, As an alternative to the DC motor with the brush, a brushless DC motor or an AC motor such as an induction motor or a synchronous motor may be adopted.

When the coil of the rotor is energized, the second motor 12 generating the drive force for driving the intake flow control valve 3 through the pin rod 4 is configured to be controlled (driven) through the H-bridge circuit 47 by the ECU 6. The ECU 6 is provided with the H-bridge circuit 47, an AND conversion circuit 48, an input/output circuit (I/O port) 49, and the microcomputer 50. The H-bridge circuit 47 is formed by bridge-connecting four MOS-FETs 51 to 54, which are referred to as a first semiconductor switching element to a fourth semiconductor switching element hereinafter. Drains of the first and third semiconductor switching elements 51, 53 are connected to a plus side of the battery. Sources of the second and fourth semiconductor switching elements 52, 54 are connected to the ground (a minus side of the battery). The coil of the second motor 12 is connected to the midway of a current path which connects an intermediate point of a first conductive wire connecting the source of the first semiconductor switching element 51 and the drain of the second semiconductor switching element 52, and an intermediate point of a second conductive wire connecting the source of the third semiconductor switching element 53 and the drain of the fourth semiconductor switching element 54.

When an ignition switch is turned ON, the ECU 6 electronically controls the first motor 11 of the electronic throttle controller and the second motor 12 of the intake vortex generating device based upon the control programs or the control logic stored in the memory of the microcomputer 50. When the ignition switch is turned OFF, each engine control based upon the control programs or the control logic is compulsorily terminated. At engine stopping, by using the drive force of the second motor 12 or the urging force of the spring, the intake flow control valves 3 may be hold at an intermediate opening state (intermediate position) where the intake flow control valve 3 is closed (or open) slightly away in the valve-closing direction (or in the valve-opening direction) from the fully open position (or the fully closed position).

The sensor signals from the valve position sensor 7 for detecting a valve position of TCV, the coolant temperature sensor 22, the air flow meter 23, and the exhaust gas sensor (air-fuel ratio sensor or oxygen sensor) 26 for detecting a state of an exhaust gas (air-fuel ratio or the like) are A/D-converted by the A/D conversion circuit 48 and thereafter, inputted through the I/O port 49 to the microcomputer 50.

The microcomputer 50 of the ECU 6 receives signals through an A/D converter 48 and an I/O port 49 from a crank angel sensor 61 which detects rotational speed of a crankshaft of the engine, an accelerator position sensors 62 which detect a stepped amount of the accelerator, a throttle position sensor 63 which detects a valve position (throttle opening angle) of the throttle valve 2, an intake temperature sensor 64 which detects an intake air temperature suctioned to the combustion chamber, a battery voltage sensor 65 which detects battery voltage of the battery which is an electric power source of the motors 11, 12, and a vehicle speed sensor which detects the travel speed (vehicle speed) of vehicles.

The coolant temperature sensor 22, the air flow meter 23, the crank angle sensor 62, the throttle position sensor 63, the intake temperature sensor 64, the battery voltage sensor 65 and the vehicle speed sensor correspond to a driving condition detecting means for detecting engine driving condition, an environment variation detecting means for detecting a variation in environment of the second motor 12, and a running condition detecting means for detecting a running condition of the vehicle.

The sensor signals from these various sensors are repeatedly read every control period of the control program or control logic stored in the memory of the microcomputer 50. The coolant temperature sensor 22 functions as a temperature sensor which detects variation in temperature correlative to the temperature of the second motor 12. The coolant temperature sensor 22 is a temperature sensor which detects the engine temperature during engine starting or immediately after engine starting. Moreover, the coolant temperature sensor 22 is the temperature sensor which detects the ambient temperature around the second motor 12. The crank angle sensor 61 is comprised of a pickup coil for converting the rotational angle of the crank shaft of the engine into an electrical signal and outputs a NE pulse signal every 30° CA.

The valve position sensor 7 is a rotational angle detecting device of a non-contact type which includes a magnet 71 fixed at the other end in the rotational shaft direction of the pin rod 4, a Hall IC 72 having a magnetic detecting element of a non-contact type for detecting the magnetic flux emitted from the magnet 71, and a division type yoke (not shown) for concentrating the magnetic flux emitted from the magnet 71 on the Hall IC 72. The valve position sensor 7 detects a valve position of TCV by using output change characteristics of the Hall IC 72 relative to the rotational angle of the pin rod 4, particularly the magnet 71. That is, the valve position sensor 7 detects the valve position of TCV based upon a change of the magnetic flux density passing through a magnetic flux detection gap formed between a pair of opposing division yokes (magnetic bodies), that is, the Hall IC 72.

The magnet 71 is a permanent magnet which generates a magnetic force for a long time period and emits the magnetic flux toward the Hall IC 72 and the division type yoke. The magnet 71 is retained and is fixed by clamping means such as an adhesive to a magnet rotor 73 rotating relatively to the actuator case and the Hall IC 72. The magnet rotor 73 retaining the magnet 71 is formed integrally with the magnet 71 by a resin material and insert-molds a sensor fixing lever 74 therein.

The magnet 71 and the magnet rotor 73 retaining the magnet 71 are retained and fixed in the sensor fixing lever 74 fitted and retained at the other end in the rotational shaft direction of the pin rod 4 in such a manner as to rotate with rotation of the plurality of the intake flow control valves 3 as a detection object and the pin rod 4. In place of the magnet 7, an electromagnet for generating a magnetic force subject to supply of power may be used. The magnet rotor 73 retaining the magnet 71 may be attached to the stopper lever 45.

The Hall IC 72 is arranged in the magnetic flux detection gap formed between the pair of the opposing yokes to form a magnetic circuit with the magnet 71. The Hall IC 71 is retained and fixed in the actuator body 5, particularly a sensor mounting portion of the actuator case. The Hall IC 72 is an IC (integrated circuit) formed by uniting a Hall element with an amplifying circuit for amplifying the output of the Hall element. The Hall element constitutes the magnetic detection element of a non-contact type of which output changes in accordance with the magnetic flux density passing through the magnetic flux detection gap (the magnetic flux density passing through the Hall IC 72). The Hall IC 72 outputs a voltage signal in accordance with the magnetic flux density passing through the magnetic flux detection gap. Thereby, a sensor output voltage is outputted from the Hall IC 72 toward ECU 6. The output signal from the Hall IC 72 (valve position signal: analogue signal) is repeatedly taken in through the A/D conversion circuit 48 in each predetermined sampling period.

The ECU 6 serves as valve position detecting means for measuring the present position of the intake flow control valve 3 based upon a valve position signal outputted from the valve position sensor 7. In place of the valve position sensor 7, a rotor position detecting means for detecting a rotor position of the second motor 12 may be provided. The ECU 6 serves as a current detecting means for detecting a current value of motor drive current flowing in the second motor 12 of the intake vortex generating device. In place of the current detecting means of the ECU 6, a current sensor may be provided for detecting the current value of the motor drive current flowing in the second motor 12. The A/D conversion circuit 48 is a sampling means for taking in the valve position signal outputted from the valve position sensor 7 in a predetermined sampling period.

The microcomputer 50 is provided with a CPU for performing control processing or calculation processing, a memory device (volatile memory such as SRAM and DRAM and involatile memory such as EPROM, EEPROM or flash memory) for storing control programs or control logic and various data, a power source circuit, a timer and the like. The microcomputer 50 serves as rotational speed detecting means for detecting an engine rotational speed (engine speed: NE) by measuring an interval time of NE pulse signals outputted from the crank angle sensor 61.

The microcomputer 50 is a motor control device for driving the H-bridge circuit 47 and includes: a valve position calculating means which calculates an actual valve position of TCV from an A/D conversion value of the output signal of the valve position sensor 7 taken in from the A/D conversion circuit 48 at every predetermined sampling timing; a PWM signal generating means (pulse signal generating means) which generates a PWM signal of a predetermined duty ratio in a predetermined period (PWM period); and a duty ratio setting means which sets a duty ratio of the PWM signal based upon a deviation between the actual valve position and a target valve position of TCV.

### [Control Method of First Embodiment]

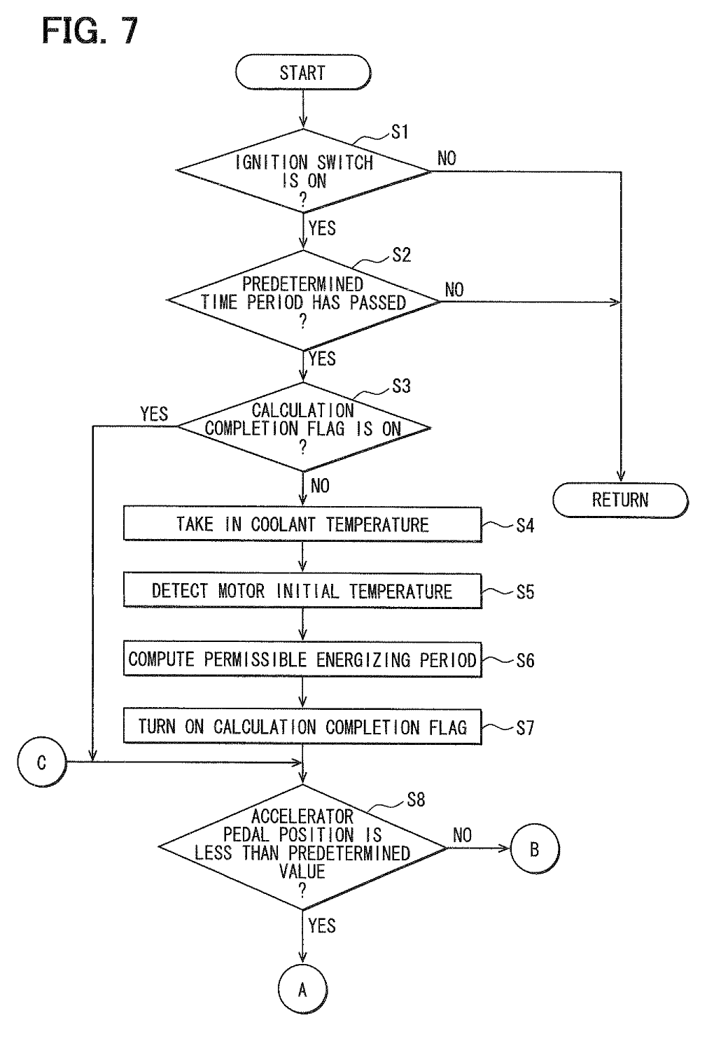

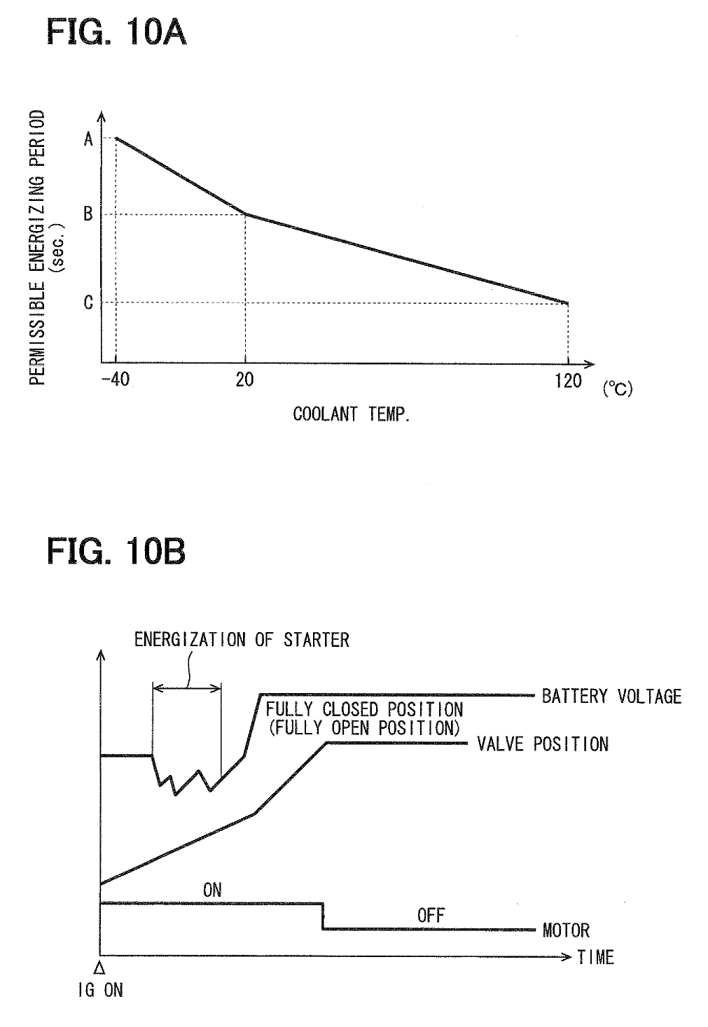

The method of controlling the intake controller (intake vortex generating device) for the internal combustion engine in the present embodiment will be explained with reference to FIGS. 1 to 10. FIGS. 7 to 9 are flow charts each showing a drive control of the H-bridge circuit by the ECU 6. FIG. 10A is a characteristic chart showing a permissible energizing period relative to the coolant temperature during or immediately after starting engine, and FIG. 10B is a timing chart showing a battery voltage, a valve position of TCV, and an energizing pattern of motor.

When the control routine in FIG. 7 is started, the computer determines whether or not the ignition switch is turned ON in step S1. When the answer is NO, the control routine in FIG. 7 ends. When the answer is YES in step S1, the procedure proceeds to step S2 in which the computer determines whether a predetermined time period (for example, 0.5-15 minutes) has passed after the ignition switch is turned ON. When the answer is NO in step S1, the control routine in FIG. 7 ends. When the answer is YES in step S2, the procedure proceeds to step S3 in which the computer determines whether a calculation completion flag is ON. When the calculation completion flag is ON, a permissible energizing period T of the second motor 12 has been calculated. When the answer is YES in step S3, the procedure proceeds to step S8.

When the answer is NO in step S3, the procedure proceeds to step S4 in which the output signal of the coolant temperature sensor 22 is taken in through the A/D conversion circuit 48. Then, the procedure proceeds to step S5 in which a motor initial temperature is detected based on the A/D converted output signal of the coolant temperature sensor 22. This process corresponds to a motor initial temperature computing means. In step S6, the computer computes the permissible energizing period “T” of the second motor 12 based on the motor initial temperature. In step S7, the calculation completion flag is turned ON.

As shown in FIG, 10A, in a case that the motor temperature is −40° C., the permissible energizing period “T” is “A” second (for example, 10 second). In a case that the motor temperature is 20° C., the permissible energizing period “T” is “B” second (for example, 6 second). In a case that the motor temperature is 120° C., the permissible energizing period “T” is “C” second (for example, 3 second). As the motor temperature is lower, the permissible energizing period “T” is set longer. As the motor temperature is higher, the permissible energizing period “T” is set shorter.

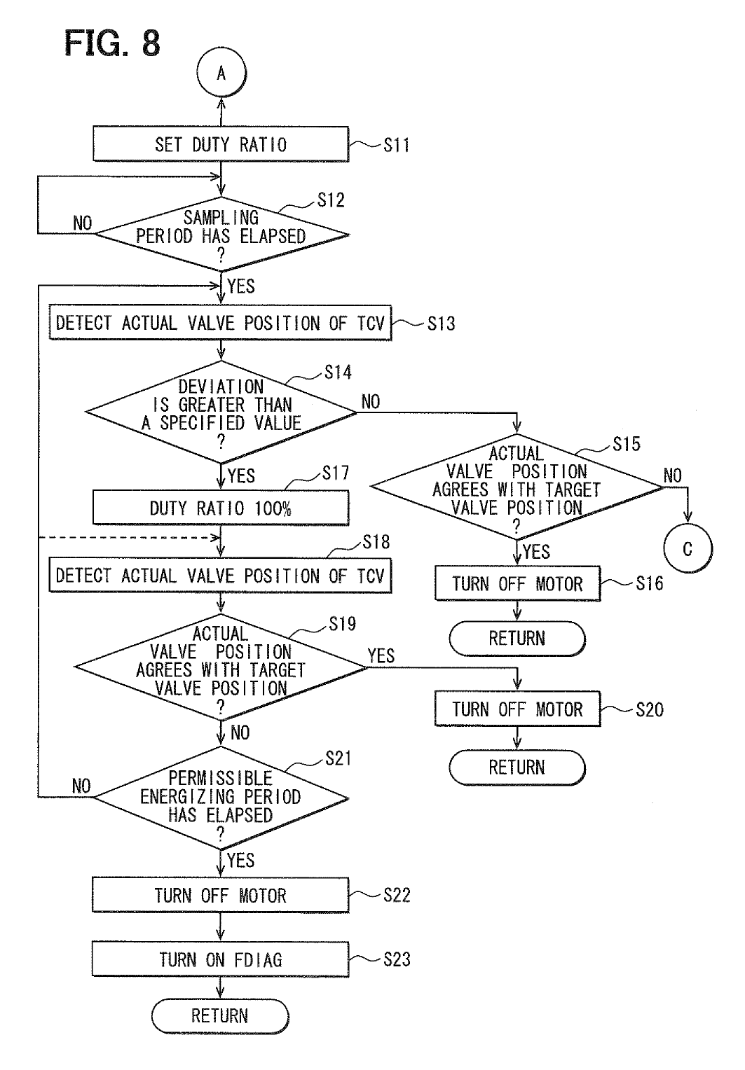

Then, the procedure proceeds to step S8 in which the computer determines whether the accelerator pedal is depressed. That is, the computer determines whether an accelerator pedal position calculated from an accelerator pedal position signal outputted from the accelerator pedal position sensor 62 is less than a predetermined value. When the answer is YES in step S8, the computer determines that the engine has been just started and the procedure proceeds to a control routine shown in FIG. 8. The target valve position is established at the fully closed position. The second motor 12 is energized so that the plurality of the intake flow control valves 3 are brought into a limit position (fully closed position) of a possible operating range. That is, a fully closed stopper portion of the stopper lever 45 retained and fixed to the outer periphery of the pin rod 4 is brought into contact with the fully closed stopper.

The limit position of the intake flow control valves 3 may be set at a fully closed point of the control which is computed according to a fully closed position learning control. In step S11, the microcomputer 50 sets a drive duty ratio (DUTY ratio) for operating the plurality of the intake flow control valves 3 in the valve-closing direction. The pulse signal in accordance with the calculated DUTY ratio is given to the H-bridge circuit 47, particularly, to the third semiconductor switching element 53. This process corresponds to a pulse signal generating means.

At this point, at the PWM signal generating means of the microcomputer 50, the PWM signal of a predetermined duty ratio controlled based upon the deviation between the actual valve position and the target valve position (fully closed position) of TCV is generated in a predetermined period. This process corresponds to a pulse signal generating means. The duty ratio of the PWM signal given to the H-bridge circuit 47, particularly, to the base of the third semiconductor switching element 53 is a ratio (ON/OFF ratio) between an ON-period of the power supply to the coil of the second motor 12 and an OFF-period of the power supply in a generation period of the PWM signal (PWM period) so that the actual valve position of TCV is equal to the target valve position (fully closed position).

As the duty ratio of the PWM signal outputted from the microcomputer 50 to the H-bridge circuit 47, particularly, to the base of the third semiconductor switching element 53 increases, the motor drive current flowing in the coil of the second motor 12 also increases. At the time of fully closing the plurality of the intake flow control valves 3, the first semiconductor switching element 51 is ON, the second semiconductor switching element 52 is OFF, the third semiconductor switching element 53 is OFF/ON and the fourth semiconductor switching element 54 is ON/OFF. In consequence, the third and fourth semiconductor switching elements 53, 54 of the H-bridge circuit 47 are PWM-controlled. Particularly, the PWM signal which is PWM-controlled based upon the deviation between the actual valve position and the target valve position (fully closed position) of TCV is inputted to the base of the third semiconductor switching element 53 of the H-bridge circuit 47. In consequence, a motor applied voltage in accordance with the duty ratio of the PWM signal is applied to the coil of the second motor 12 of the intake vortex generating device and the motor drive current in the valve-closing direction (plus direction) flows in the coil of the second motor 12.

Then, the procedure proceeds to step S12 in which the computer determines whether a sampling period of output signal of the valve position sensor 7, which is shorter than the permissible energizing period “T”, has elapsed after the second motor 12 is energized. The sampling period is 3-10 second, for example. The output signal of the valve position senor 7 is sampled for A/D conversion in this sampling period. When the answer is NO in step S12, the determination process at step S12 is repeated. When the answer is YES in step S12, the procedure proceeds to step S13 in which the output signal of the valve position sensor 7 is taken through the A/D conversing circuit 48, and the actual valve position of TCV is detected (calculated) based upon the A/D conversion value of the output signal of the valve position sensor 7 which is converted from an analogue signal to a digital signal at the A/D conversion circuit 48. This process corresponds to a valve position calculating means.

Then, the procedure proceeds to step S14 in which the computer determines whether a deviation between the actual valve position and the target valve position (fully closed position) is greater than a specified value. When the answer is NO in step S14, the procedure proceeds to step S15 in which the computer determines whether the actual valve position of TCV agrees with the target valve position (fully closed position). When the answer is NO in step S15, the procedure goes back to step S8. When the answer is YES in step S15, the procedure proceeds to step S16 in which the motor voltage or the driving duty ratio applied to the second motor 12 is brought to be minimum. For example, the driving duty ratio is established as 0%. The microcomputer 50 established the duty ratio of the PWM signal as 0%, which is applied to the H-bridge circuit 47, particularly, to the base of the third semiconductor switching element 53. That is, the electric power supply to the second motor 12 is stopped. Thereafter, the control routine in FIG. 8 ends.

When the answer is YES in step S14, the procedure proceeds to step S17 in which the motor voltage or the driving duty ratio applied to the second motor 12 is brought to be maximum. For example, the driving duty ratio is established as 100%. The microcomputer 50 establishes the duty ratio of the PWM signal as 100%, which is applied to the H-bridge circuit 47, particularly, to the base of the third semiconductor switching element 53. Then, the procedure proceeds to step S18 in which the actual valve position of TCV is computed based on the A/D conversion value of the output signal of the valve position sensor 7 which is converted from an analogue signal to a digital signal at the A/D conversion circuit 48. This process corresponds to a valve position calculating means.

Then, the procedure proceeds to step S19 in which the computer determines whether the actual valve position of TCV agrees with the target valve position (fully closed position). When the answer is YES in step S19, the procedure proceeds to step S20 in which the motor voltage or the driving duty ratio applied to the second motor 12 is brought to be minimum. For example, the driving duty ratio is established as 0%. The microcomputer 50 established the duty ratio of the PWM signal as 0%, which is applied to the H-bridge circuit 47, particularly, to the base of the third semiconductor switching element 53. That is, the electric power supply to the second motor 12 is stopped. Thereafter, the control routine in FIG. 8 ends.

When the answer is NO in step S19, the procedure proceeds to step S21 in which the computer determines whether the permissible energizing period “T” has elapsed after the DUTY ratio and the duty ratio of the PWM signal are set to 100%. When the answer is NO in step S21, the procedure goes back to step S13 or step S18. When the answer is YES in step S21, the procedure proceeds to step S22 in which the duty ratio of the PWM signal is set to 0%, which is applied to the H-bridge circuit 47, particularly, to the base of the third semiconductor switching element 53. That is, the electric power supply to the second motor 12 is stopped. Then, the procedure proceeds to step S23 in which a motor-sensor diagnosis flag (FDIAG) is turned ON. Thereafter, the control routine in FIG. 8 ends. When the FDIAG is turned ON, failures of the motors or the sensors are stored in the memory of the microcomputer 50 and a warning lump is turned ON to notify the failures of the motors or the sensors.

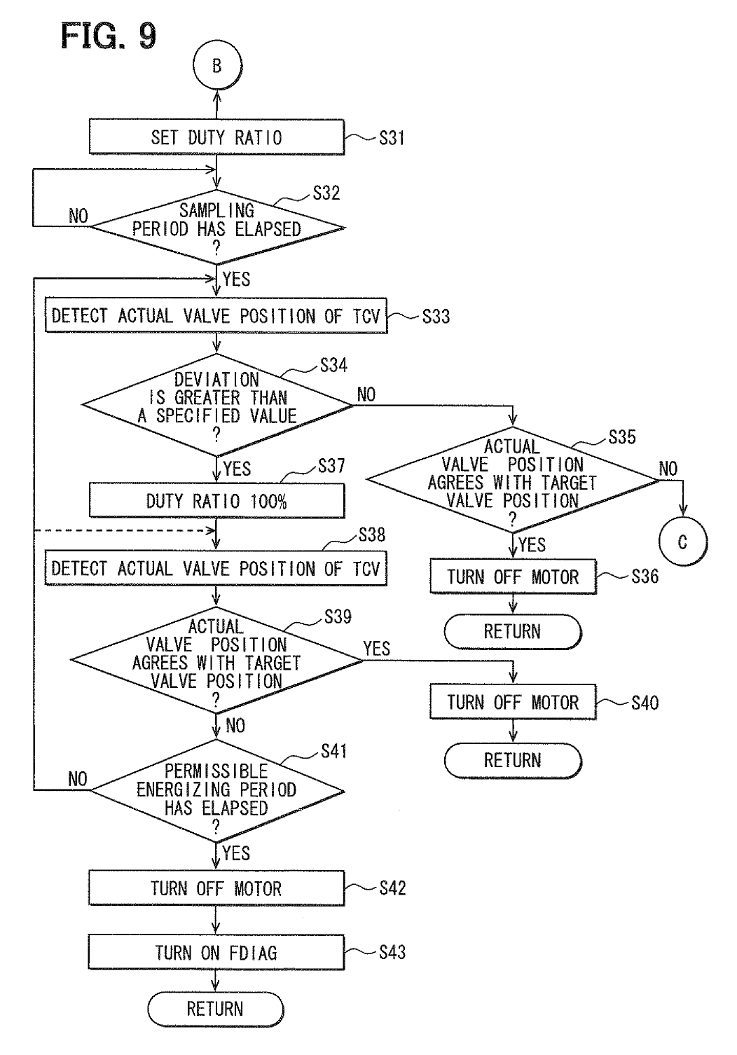

When the answer is NO in step S8, the procedure proceeds to a control routine shown in FIG. 9 and the target valve position is set to the fully open position The second motor 12 is energized so that the plurality of the intake flow control valves 3 are brought into a limit position (fully open position) of a possible operating range. That is, a fully open stopper portion of the stopper lever 45 retained and fixed to the outer periphery of the pin rod 4 is brought into contact with the fully open stopper.

The limit position of the intake flow control valves 3 may be set at a fully open point of the control which is computed according to a fully open position learning control. In step S31, the microcomputer 50 sets a drive duty ratio (DUTY ratio) for operating the plurality of the intake flow control valves 3 in the valve-opening direction. The PWM signal in accordance with the calculated DUTY ratio is given to the H-bridge circuit 47, particularly, to the base of the second semiconductor switching element 52 in step S26. This process corresponds to a pulse signal generating means. At this point, in the PWM signal generating means of the microcomputer 50, the PWM signal of the predetermined duty ratio which is controlled based upon the deviation between the actual valve position and the target valve position (fully open position) of TCV is generated in a predetermined period. This also corresponds to the pulse signal generating means.

At the time of fully opening the plurality of the intake flow control valves 3, the first semiconductor switching element 51 is ON, the second semiconductor switching element 52 is ON/OFF, the third semiconductor switching element 53 is OFF/ON and the fourth semiconductor switching element 54 is OFF. In consequence, the second and third semiconductor switching elements 52, 53 of the H-bridge circuit 47 are PWM-controlled. Particularly, the PWM signal which is PWM-controlled based upon the deviation between the actual valve position and the target valve position (fully open position) of TCV is inputted to the base of the second semiconductor switching element 52 of the H-bridge circuit 47. In consequence, the motor applied voltage in accordance with the duty ratio of the PWM signal is applied to the coil of the second motor 12 and the motor drive current in the valve-open direction (reverse direction to the valve-closing direction) flows in the coil of the second motor 12.

Then, the procedure proceeds to step S32 in which the computer determines whether a sampling period of output signal of the valve position sensor 7, which is shorter than the permissible energizing period “T”, has elapsed after the second motor 12 is energized. The sampling period is 3-10 second, for example. The output signal of the valve position senor 7 is sampled for A/D conversion in this sampling period. When the answer is NO in step S32, the process in step S32 is performed repeatedly. When the answer is YES in step S32, the procedure proceeds to step S33 in which the output signal of the valve position sensor 7 is taken through the A/D conversing circuit 48, and the actual valve position of TCV is detected (calculated) based upon the A/D conversion value of the output signal of the valve position sensor 7 which is converted from an analogue signal to a digital signal at the A/D conversion circuit 48. This process corresponds to a valve position calculating means.

Then, the procedure proceeds to step S34 in which the computer determines whether a deviation between the actual valve position and the target valve position (fully open position) is greater than a specified value. When the answer is NO in step S34, the procedure proceeds to step S35 in which the computer determines whether the actual valve position of TCV agrees with the target valve position (fully open position). When the answer is NO in step S35, the procedure goes back to step S8. When the answer is YES in step S35, the procedure proceeds to step S36 in which the motor voltage or the driving duty ratio applied to the second motor 12 is brought to be minimum. For example, the driving duty ratio is established as 0%. The microcomputer 50 established the duty ratio of the PWM signal as 0%, which is applied to the H-bridge circuit 47, particularly, to the base of the second semiconductor switching element 52. That is, the electric power supply to the second motor 12 is stopped. Thereafter, the control routine in FIG. 9 ends.

When the answer is YES in step S34, the procedure proceeds to step S37 in which the motor voltage applied to the second motor 12 or the driving duty ratio (DUTY ratio) is brought to be maximum. For example, the driving duty ratio (DUTY ratio) is established as 100%. The microcomputer 50 establishes the duty ratio of the PWM signal as 100%, which is applied to the H-bridge circuit 47, particularly, to the base of the second semiconductor switching element 52. Then, the procedure proceeds to step S38 in which the actual valve position of TCV is computed based on the AD conversion value of the output signal of the valve position sensor 7 which is converted from an analogue signal to a digital signal at the A/D conversion circuit 48. This process corresponds to a valve position calculating means.

Then, the procedure proceeds to step S39 in which the computer determines whether the actual valve position of TCV agrees with the target valve position (fully open position). When the answer is YES in step S39, the procedure proceeds to step S40 in which the motor voltage applied to the second motor 12 or the driving duty ratio (DUTY ratio) is brought to be minimum. For example, the driving duty ratio is established as 0%. The microcomputer 50 establishes the duty ratio of the PWM signal as 0%, which is applied to the H-bridge circuit 47, particularly, to the base of the second semiconductor switching element 52. That is, the electric power supply to the second motor 12 is stopped. Thereafter, the control routine in FIG. 9 ends.

When the answer is NO in step S39, the procedure proceeds to step S41 in which the computer determines whether the permissible energizing period “T” has elapsed after the DUTY ratio and the duty ratio of the PWM signal are set to 100%. When the answer is NO in step S41,the procedure goes back to step S33 or step S38. When the answer is YES in step S41, the procedure proceeds to step S42 in which the duty ratio of the PWM signal is set to 0%, which is applied to the H-bridge circuit 47, particularly, to the base of the second semiconductor switching element 52. That is, the electric power supply to the second motor 12 is stopped. Then, the procedure proceeds to step S43 in which a motor-sensor diagnosis flag (FDIAG) is turned ON. Thereafter, the control routine in FIG. 9 ends. When the FDIAG is turned ON, failures of the motors or the sensors are stored in the memory of the microcomputer 50 and a warning lump is turned ON to notify the failures of the motors or the sensors.

### [Advantages of First Embodiment]

According to the first embodiment, when a situation in which the motor voltage and the driving duty ratio (DUTY ratio) applied to the second motor 12 are maximum continues for the permissible energizing period “T” or more, the motor voltage and the driving duty ratio are varied to minimum values (DUTY ratio: 0%) so that the electric power supply to the second motor 12 is stopped. Hence, the thermal damage to the coil of the second motor 12 can be avoided.

On the other hand, in a case that an ambient temperature is very low, for example, −35° C., a deposit adhering on a vicinity of the intake flow control valve 3 is harden, the intake flow control valve 3 is frozen, or viscosity of lubricant increases. The driving load of the motor 12 increases, and control responsiveness of the intake flow control valve 3 and the motor 12 deteriorates.

In such a situation, if the intake flow control valves 3 are rotated from the fully open position (fully closed position) to the fully closed position (fully open position) that is the target valve position, the motor voltage and the driving duty ratio (DUTY ratio) becomes maximum and the electric power supply to the motor 12 is stopped before the valve position of the intake flow control valves 3 reach the target valve position. Thereby, the full-close operation of the intake flow control valves 3 can not be performed, and the sufficient tumble flow can not be generated in the combustion chamber of the internal combustion engine. Alternatively, the full-open operation of the intake flow control valves 3 can not be performed.

According to the first embodiment, the computer computes the permissible energizing period “T” of the second motor 12 based on the motor initial temperature which is computed based on the AID conversion value of the output signal of the coolant temperature sensor 22. Especially, as the motor initial temperature is lower, the permissible energizing period “T” is set longer.

Therefore, even if the responsiveness of the intake flow control valves 3 or the second motor 12 deteriorates due to extremely low temperature, the situation in which the motor voltage and the driving duty ratio (DUTY ratio) applied to the second motor 12 are maximum continues for a long period as shown in FIG. 10B, so that the energizing period of the motor 12 can be set longer than the conventional apparatus. Thereby, the actual valve position of TCV can be controlled to the target valve position. Besides, as shown in FIG. 10B, when the engine is started, the battery voltage is temporarily decreased due to an energization of the starter and an ambient temperature decrease. According to the first embodiment, since the motor 12 is energized even when the battery voltage is temporarily decreased, an ordinal battery voltage is applied to the motor as the motor voltage.

When the intake flow control valves 3 is fully closed, the intake air flows through the opening 42 toward an upper portion of the intake port 16. The intake air flowing along the ceiling wall surface of the upper layer portion of the intake port 16 is supplied from a port opening of the intake port 16 into the combustion chamber. At this time, since a tumble flow is generated in the combustion chamber in each cylinder of the engine, the combustion efficiency improves in the combustion chamber at engine starting or at idling to improve fuel economy, exhaust emissions (for example, HC reduction effect) or the like.

When the intake flow control valves 3 is fully opened, the intake air flows through the second intake passage 32 straight toward the intake port 16. The intake flow which has flowed through the intake port 16 is supplied from the port opening of the intake port 16 into the combustion chamber. At this time, the tumble flow is not generated in the combustion chamber in each cylinder of the engine. The pressure loss does not increase in the first and the second intake passage 31, 32. Hence, when the throttle valve 2 is fully opened, there is no factor generating pumping loss, so that the sufficient intake air flow rate can be ensured. Thus, a deterioration in engine output can be avoided.

### Second Embodiment

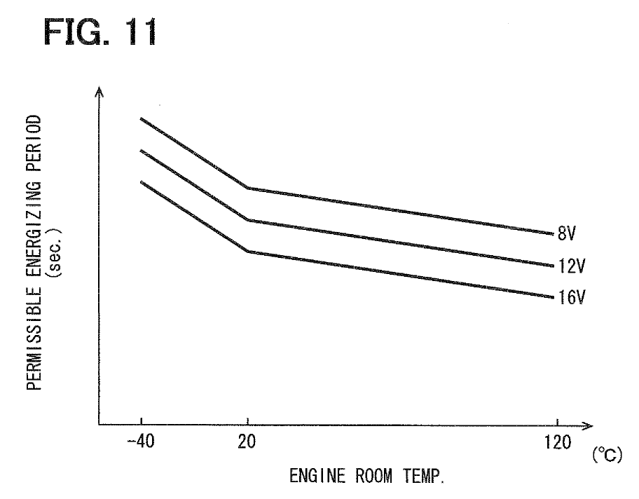

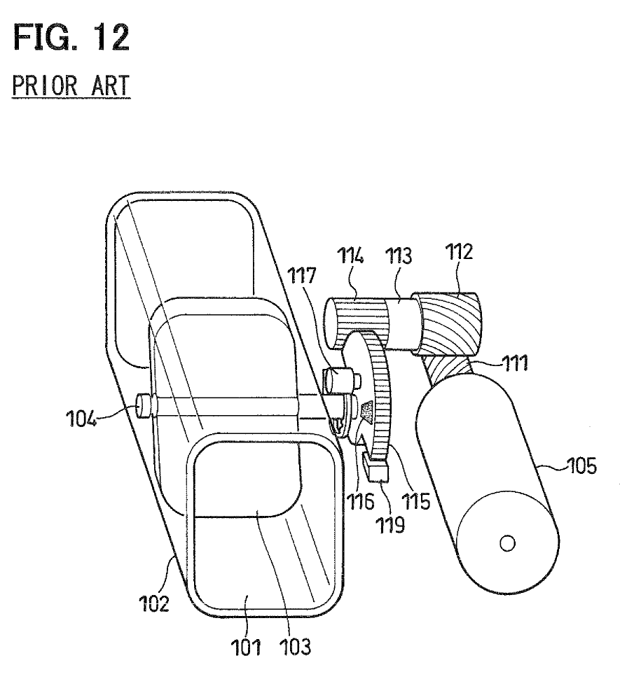

FIG. 11 is a characteristic chart showing the permissible energizing period “T” relative to an engine room temperature (or ambient temperature) and the battery voltage.

In the present embodiment, the permissible energizing temperature is established based on a temperature signal from an engine room temperature sensor or an ambient temperature sensor, and a battery voltage signal from the battery voltage sensor 65. As the engine room temperature or the ambient temperature becomes lower, and as the battery voltage becomes lower, the permissible energizing period is set longer.

### [Modification]

In the above embodiments, the controller for the internal combustion engine is applied to the intake controller for the internal combustion engine provided with the intake vortex generating device. The controller may be applied to an electronic throttle controller for an internal combustion engine controlling an intake air flow rate by opening/closing an intake passage of the engine or an intake variable controller for an internal combustion engine changing a passage length or a passage cross sectional area of an intake passage by opening/closing the intake passage of the engine.

Moreover, the controller may be applied to an exhaust gas controller which is provided with an exhaust gas control valve controlling an exhaust gas discharged from the combustion chamber. Moreover, the controller may be applied to an EGR controller provided with an EGR control valve which controls exhaust gas recirculation amount.

In the present embodiment, the intake vortex generating device is constructed to be capable of generating the longitudinal intake vortex (tumble flow) for promoting combustion of a mixture in the combustion chamber of each cylinder in the engine, but the intake vortex generating device may be constructed to be capable of generating a lateral intake vortex (swirl flow) for promoting combustion of a mixture in the combustion chamber of each cylinder in the engine. Further, the intake vortex generating device may be constructed to be capable of generating a squish vortex for promoting combustion of the engine.

In the present embodiment, the actuator for driving the valve shaft 41 of the intake flow control valve 3 is formed of the second motor 12 and the power transmission mechanism (for example, gear reduction mechanism), but the actuator for driving the shaft of the valve may be formed of the motor only. The shaft of the valve may be directly driven without through the pin rod 4. A valve urging means such as a spring for urging the valve in the valve-opening direction or in the valve-closing direction may be or may not be provided.

As the intake control valve including the valve installed in the intake passage formed inside the casing such as the intake pipe or the intake manifold to control intake air aspired into the combustion chamber for the internal combustion engine, in place of the TCV (tumble flow control valve) in the present embodiment, there may be provided an intake flow quantity control valve including a throttle valve installed in the intake passage formed inside the throttle body to control intake air aspired into the combustion chamber for the internal combustion chamber, or an intake flow quantity control valve including an idle rotational speed control valve installed in the intake passage formed inside the housing to control a flow quantity of intake air bypassing the throttle valve.

Further, as the intake control valve formed of the casing (or housing) and the intake flow control valve, an intake passage opening/closing valve, an intake passage switching valve or an intake pressure control valve may be used in place of the intake flow control valve or the intake flow quantity control valve. The intake control valve may be applied to an intake flow control valve such as a tumble flow control valve or a swirl flow control valve, or an intake variable valve changing a passage length or a passage cross sectional area of the intake passage for the internal combustion engine. As the intake flow control valve, in place of the rotary valve, a poppet type valve may be used. in this case, a motion-direction converting mechanism is provided in the actuator. A diesel engine may be used as the internal combustion engine. Further, not only the multi-cylinder engine but also a single-cylinder engine may be used as the internal combustion engine.

The present embodiment adopts a multiple one-piece valve opening/closing device (intake passage opening/closing device) where a plurality of valve units are arranged at constant intervals in the rotational shaft direction of the pin rod 4 inside the intake manifold 1 as the casing, each valve unit (cartridge) assembling one intake flow control valve 3 inside one housing 35 for the intake flow control valve 3 to open or close therein. However, there may be adopted a multiple one-piece valve opening/closing device (intake passage opening/closing device) where a plurality of valves are directly arranged at constant intervals in the rotational shaft direction of the shaft inside the casing (another intake pipe, engine head cover or cylinder head). In this case, the housing 35 can be abolished.

The intake control valve is not limited to the multiple one-piece intake control valve, but if the valve is arranged in the intake passage for the internal combustion engine, one intake control valve may be used.

The above present embodiments, as the intake control valve driven by the motor as the power source, adopt the cantilever intake flow control valve 3 in which the rotational shaft (valve shaft) constituting the rotational center is arranged in a position shifted to the half side in the valve surface direction perpendicular to the plate thickness direction of the intake flow control valve 3. However, as the intake control valve driven by the motor as the power source, a shaft-centered type intake control valve (butterfly type valve) can be adopted. The rotational shaft (valve shaft) constituting the rotational center is arranged in a position substantially in the central portion in the valve surface direction perpendicular to the plate thickness direction of the intake flow control valve 3.

The driving duty ratio of the motor 12 or the duty ratio of the PWM signal may be corrected according to the battery voltage signal from the battery voltage sensor 65 and the coolant temperature signal from the coolant temperature sensor 22. In this case, as the battery voltage increases, the drive duty ratio of the second motor 12 or the duty ratio of the PWM signal is set (corrected) to the larger value. As the coolant temperature (or environment temperature in the circumference of the second motor 12) increases, the drive duty ratio of the second motor 12 or the duty ratio of the PWM signal is set (corrected) to the larger value.

In the above embodiments, the engine room temperature sensor or the ambient temperature sensor detects the ambient temperature around the second motor 12. Alternatively, a room temperature sensor detecting a room temperature of the vehicle, an actuator temperature sensor detecting an actuator temperature, a motor temperature sensor detecting motor temperature, or a switching element temperature sensor detecting switching element temperature may be used as the temperature sensor detecting the ambient temperature around the second motor 12. Alternatively, the coolant temperature sensor 22, the intake air temperature sensor 64, or an intake pipe temperature sensor detecting intake pipe temperature can be used as the temperature sensor detecting ambient temperature around the second motor 12.

In the above embodiments, the coolant temperature sensor 22 detects the engine temperature at starting engine or immediately after engine starting. Alternatively, the room temperature sensor, the engine room temperature sensor, the actuator temperature sensor, the motor temperature sensor, the switching element temperature sensor, the intake air temperature sensor 64, the intake pipe temperature sensor, a lubricant temperature sensor or a grease temperature sensor detecting grease temperature of a bearing can be used as the temperature sensor detecting the engine temperature. In the above embodiments, the motor energizing period control is performed within a preset time period after the ignition switch is turned ON. Even after the preset time period has elapsed, the motor energizing period control can be periodically performed.

What is claimed is:

1. A controller for an internal combustion engine, comprising: a valve disposed in a fluid passage communicated with a combustion chamber of the internal combustion engine, the valve opening/closing the fluid passage; a motor for generating a drive force driving the valve on receiving an electric power supply; and a control unit restricting the electric power supply to the motor when the electric power to the motor has been maximum for a specified period, or when a continuous energizing period of the motor exceeds the specified period, wherein the control unit includes a temperature sensor which detects a temperature correlative to a motor temperature, and the control unit makes the specified period longer as the temperature detected by the temperature sensor is lower.

2. A controller for an internal combustion engine according to claim 1, wherein the temperature sensor detects an ambient temperature around the motor.

3. A controller for an internal combustion engine according to claim 1, wherein the temperature sensor detects a temperature of the internal combustion engine during or immediately after starting.

4. A controller for an internal combustion engine according to claim 1, wherein when the electric power to the motor is maximum, a motor voltage or a duty ratio applied to the motor is maximum.

5. A controller for an internal combustion engine according to claim 1, wherein when the electric power to the motor is maximum, a motor driving current or an amount of electric current supplied to the motor is maximum.

6. A controller for an internal combustion engine according to claim 1, wherein the control unit includes a valve position sensor detecting a valve position of the valve, the control unit detects an actual valve position of the valve based on an output of the valve position sensor; and the control unit feedback controls the electric power supply to the motor in such a manner that the actual valve position agrees with a target valve position of the valve.

7. A controller for an internal combustion engine according to claim 6, wherein the control unit includes an H-bridge circuit having four switching elements connected in H-bridge shape relative to the motor, and a computer controlling the H-bridge circuit.

8. A controller for an internal combustion engine according to claim 7, wherein the motor is electrically connected to a battery through the H-bridge circuit, and the computer makes the specified period longer as a battery voltage is lower.

9. A controller for an internal combustion engine according to claim 7, wherein: the computer includes a pulse signal generating means which generates a pulse signal of a predetermined duty ratio in a predetermined period, and duty ratio setting means which sets a duty ratio of the pulse signal based upon a deviation between the actual position and the target position of the valve, when the electric power to the motor is maximum, the duty ratio of the pulse signal outputted to the H-bridge circuit from the computer is maximum.

10. A controller for an internal combustion engine according to claim 1, wherein the valve includes an intake flow control valve which generates an intake vortex in the combustion chamber for the internal combustion engine.
